(19) United States
(12) Patent Application Publication
(10) Pub. No.: US 2017/0085946 A1
(43) Pub. Date: Mar. 23, 2017

(54) METHOD AND DEVICE FOR IDENTIFYING A CONTENT BEING DISPLAYED ON A SCREEN

(71) Applicant: VIACCESS, Paris (FR)

(72) Inventor: Emmanuel PIRA, Melesse (FR)

(73) Assignee: VIACCESS, Paris (FR)

(21) Appl. No.: 15/126,113

(22) PCT Filed: Mar. 19, 2015
(86) PCT No.: PCT/EP2015/055787

§ 371 Date: Sep. 14, 2016

(30) Foreign Application Priority Data
Mar. 20, 2014 (FR) 1452336

(51) Int. Cl. H04N 21/44; G06K 9/46; H04N 21/442; H04N 21/4223; H04N 21/8352; H04N 21/41

(52) U.S. Cl. CPC H04N 21/44008; H04N 21/8352; H04N 21/4104; H04N 21/44231; H04N 21/4223; G06K 9/4661

(57) ABSTRACT

A method for identifying, via a first terminal, a content being displayed on a screen of a second terminal located in the same space as the first terminal includes collecting with the first terminal the luminosity produced in the space by the screen of the second terminal, generating with the first terminal at least one digital fingerprint depending on the collected luminosity, comparing the fingerprint generated to a reference fingerprint stored beforehand in a memory, and identifying the content depending on the result of the comparison.

### TECHNICAL FIELD

The invention relates to a method and a device for identifying, via a first terminal, a content being displayed on a screen of a second terminal located in the same space as the first terminal.

The invention also relates to a communication terminal suitable for identifying a content being displayed on a screen of a second terminal located in the same space as the communication terminal.

The invention further relates to a computer program stored on a storage medium and including instructions for carrying out the steps of the method.

### STATE OF PRIOR ART

Increasing improvements in telecommunication techniques and devices enable actors from the audio-visual sector to associate with contents provided to the users additional services such as, for example, real time interactivity, via professional and/or recreational applications.

To that end, digital contents displayed on a terminal have to be identified in real time when being displayed.

Techniques from prior art used for identifying real time contents when being displayed rely on the analysis of these contents themselves, whether for computing a digital fingerprint thereof, or inserting and then detecting a brand therein.

Because of their complexity, the execution of these techniques rely on hardware or software implementations, in the receiving devices, in particular, of sensors and processors dedicated to the computation of the fingerprint, or to the detection and analysis of the brand inserted in the content. These implementations are demanding in terms of computational resources and increase the complexity and cost of the receiving terminals.

One object of the invention is to allow an automatic identification of a real time content when being displayed, demanding little computational resources and simple to implement, by means of the existing terminals.

### DISCLOSURE OF THE INVENTION

This purpose is achieved by means of a method for identifying via a first terminal, a content being displayed on a screen of a second terminal located in the same space as the first terminal, this method comprising the following steps:
collecting with the first terminal the luminosity produced in said space by the screen of the second terminal;
generating with the first terminal at least one digital fingerprint depending on the collected luminosity;
comparing the generated fingerprint to a reference fingerprint stored beforehand in a memory;
and identifying the content depending on the result of said comparison.

In a first alternative execution of the method, the reference fingerprint is transmitted beforehand to said first terminal, and the comparison of the generated digital fingerprint to the reference fingerprint is performed by the first terminal.

In a second alternative, the first terminal transmits the generated digital fingerprint to a server which compares said generated fingerprint to the reference fingerprint.

In both alternatives, the comparison of the generated digital fingerprint to the reference fingerprint consists in computing a distance between said fingerprints; the content being then identified if the distance computed is lower than a predefined threshold.

Alternatively, the comparison of the generated digital fingerprint to the reference fingerprint consists in computing a correlation between said fingerprints; the content being then identified if the computed correlation is higher than a predefined threshold.

Preferentially, the method according to the invention further includes a step of synchronising an application, called application Second Screen operating on the first terminal with the display of the digital content identified on the screen of the second terminal

By virtue of the method according to the invention, upon displaying a content, a movie or a sports event for example, the operator could associate with this content different additional services, such as buying a report relating to a town where the movie or the sports event occurs, or even the invitation to participate in a survey regarding this town. The operator could also modify in real time the additional services depending on the evolution of the movie or the event being displayed.

It is to be noted that the method according to the invention enables not only the digital contents provided to be identified, but also a sequence instant of the program to be identified. This instant can correspond to the start of collecting luminosity, the end of collecting luminosity, the instant of sending the answer identifying the content, or the instant at which an additional service should be offered to the user.

Indeed, in a known manner per se, with each image of a digital content broadcasted by an operator, is associated a time code including a date expressed in hours, minutes, seconds and image number. This time code enables each image of the content to be retrieved after the identification thereof. Thus, it is possible to obtain the fingerprint position, that is, the position from the beginning of the program, with the predefined duration during which the luminosity collection which gave rise to the fingerprint generation has been made.

The method according to criteria the invention takes advantage of such information to obtain the position of each fingerprint in the content and to synchronise the application Second Screen with an identified content.

In a first embodiment, the luminosity is measured by means of a sensor integrated in to the first terminal.

In another embodiment, the luminosity is computed from images acquired by means of a camera integrated in to the first terminal.

In the latter embodiment, the digital fingerprint is computed from three colour components of the images acquired for a predefined collection duration. This computation is for example made by summing the luminosity values of the components.

In order to improve the identification accuracy, it is also possible to generate a fingerprint per component, and then to compare each of them with the corresponding component of the reference fingerprint. It is also possible to generate any combination of these fingerprints representing the change over time in luminosity, which fingerprints are computed from the different colour components of the images acquired for the predefined duration.

The method according to the invention is executed by means of a device including:
a memory including a plurality of reference digital fingerprints, each reference fingerprint enabling a content to be identified among the contents provided,
a terminal provided with means for collecting the luminosity produced in a space by the second terminal, and means for generating a digital fingerprint from the collected luminosity,
means for comparing the generated digital fingerprint to a reference fingerprint stored beforehand in the memory, and
means for identifying the displayed content.

This device further includes means for synchronising an application operating on the first terminal with the real time display of a digital content identified.

Said terminal can be a smartphone, a tablet or a computer including means for collecting the luminosity produced by displaying a content displayed on a screen, means for generating a digital fingerprint depending on the collected luminosity, means for comparing the generated digital fingerprint to a reference fingerprint stored beforehand in a memory, and means for identifying the displayed content.

### BRIEF DESCRIPTION OF THE DRAWINGS

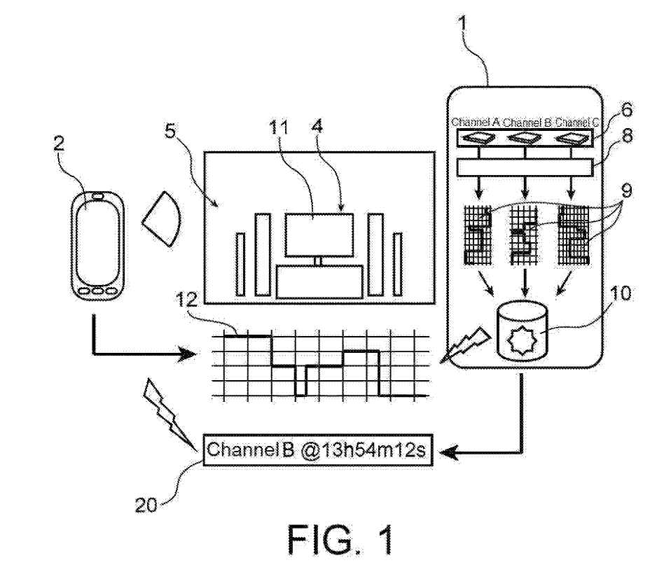

Further characteristics and advantages of the invention will become more apparent from the description that follows, taken by way of non-limiting example, with reference to FIG. 1 representing a scheme of a facility in which the method according to the invention is executed.

### DETAILED DISCLOSURE OF PARTICULAR EMBODIMENTS

FIG. 1 schematically represents a facility including a flagship 1, a first terminal 2 for a user, and a second terminal 4 arranged in the same space 5 as the first terminal 2 and playing an audio-visual program provided by the flagship 1.

In the description that follows, it is considered that the luminosity produced by displaying, via the second terminal 4, a content, is propagated at any point of the space 5. The first terminal 2 can thus collect this luminosity, regardless of its position in the space 5, without the need of aiming at the screen of the second terminal 4. The space 5 is for example a same room of given premises, such as a living-room, an office or a bedroom of a house or an apartment, or such as a set of such rooms opened on each other.

The flagship 1 includes a transmitter 6 likely to broadcast a package of audio-visual programs and a fingerprint computer server 8 comprising a processing module programmed for computing on the flight a reference fingerprint 9, for example by image analysis and processing, for each program broadcasted. The reference fingerprints 9 computed are stored in a memory 10.

The broadcasting can be made on a satellite or terrestrial network, for example. It can be for example a streaming broadcast, in particular on the Internet.

Alternatively, in particular in the case of on-demand video contents, these contents can then be provided as downloading files. Finally, the contents can be provided as files stored beforehand on any removable physical medium such as a disc or a key. The full fingerprints, that is on their entire duration, are consequently computed therefrom and stored in the memory 10.

The memory 10 is a simple computing memory, or a more structured and tooled data base, for forming inquiries in particular.

The first terminal 2 is able to communicate with the flagship 1 and includes a luminosity sensor which preferentially has a sensitivity which is automatically adapted depending on the ambient luminosity and a computing module suitable for transforming a collected luminosity into a digital fingerprint. This first terminal 2 further includes a multimedia application, called an application Second Screen, in the following of this description, which cooperates with a search module placed at the flagship 1 to provide to the first terminal 2 additional data regarding a broadcasting content. These data relate in particular to a game in connection with the displayed content, or even a survey in connection with the displayed content.

In order to improve the reactivity of the application Second Screen and to avoid a congestion of the fingerprint computing server 8, the fingerprints generated by the fingerprint computing server 8 can, at least partly, be pre-loaded for analysis in the first terminal 2 upon activating the application Second Screen on the terminal 2.

To the same purpose, additional data can also be, at least partly, pre-loaded in the first terminal 2.

It is to be noted that if the first terminal 2 is a smartphone, a tablet or a laptop computer, the acquisition of luminosity in the space 5 can be made by means of the luminosity sensor generally integrated into this first terminal 2, or by means of a camera associated with this first terminal 2. In the latter case, a processing of the image acquired enables the luminosity to be extracted therefrom.

During the luminosity collecting phase, the length of the collected signal can be set as depending on the number of contents available at the flagship 1.

Alternatively, the total length of the signal to be collected may not be predetermined, but reached by successive increments with a predetermined length. In this case, the luminosity collection and digital fingerprint generation are successively performed for adjacent or non-adjacent segments, of the content, and the generated digital fingerprint for each of these segments is transmitted in real time to the server. The iteration is stopped when the fingerprints generated for each of these segments enable a decision to be made, that is the content being displayed to be identified, or the impossibility to identify it to be diagnosed, or when the length of the collected signal exceeds a predetermined limit.

As is illustrated in FIG. 1, a digital fingerprint 12 generated by the first terminal 2 is represented by a curve illustrating the change over time in the collected luminosity. This fingerprint is characterised by a first parameter representing a time value on the abscissa axis. The ordinate axis corresponds to a luminosity value measured by a sensor integrated into a first terminal 2 or computed in the case of an acquisition via a camera.

In order to make the samples comparable and to minimise the influence of the distance and the sensitivity of the sensor, the luminosity value can be normalised on a scale from 0 to 100, for example.

When the user desires to benefit from services associated with an audio-visual program being displayed, he/she activates the application Second Screen and places the first terminal 2 into the space 5 so as to collect the luminosity variations produced in this space by the images displayed on the screen 11 of the second terminal 4 for a predefined luminosity collecting duration. The collected luminosity is transformed by the computing module of the first terminal 2 into a digital fingerprint 12 which results from sampling of the luminosity produced by the second terminal 4 for the predefined collecting duration. The unit time interval which makes up this predefined collecting duration of the luminosity depends on the sampling frequency of the collected signal. Thus, for example, for values of sampling frequencies of 0.5 Hz, 1 Hz, 5 Hz, and 10 Hz, the unit time interval has a duration of 2 seconds, 1 second, ⅕ second and 1/10 second respectively. An exemplary representative curve 12 of a fingerprint is given by way of example in FIG. 1 for determined duration and sampling frequency. The predefined luminosity collecting duration, or the length of the generated fingerprints, can be equal to an integer number of unit samples and can for example be in the order of five to a few tens of times the duration of this unit time interval.

In a first embodiment, the first terminal 2 transmits the digital fingerprint 12 via the application Second Screen, to the fingerprint computing server 8 for example via a Wi-Fi connection, a data link through GSM, or an SMS.

If the length of the digital fingerprint is generated by successive increments, upon receiving this fingerprint by a first content segment, the fingerprint computing server 8 searches for the corresponding reference fingerprint 9 in the memory 10. And when the length of the collected signal is sufficient to allow a decision, that is if the content is identified or if the memory 10 does not contain a fingerprint enabling the content to be identified, the fingerprint computing server 8 informs the application Second Screen about it, which stops the collection. Otherwise, the fingerprint computing server 8 informs the application Second Screen about it, which reiterates the collection. Then, the fingerprint computing server 8 concatenates the fingerprints thus obtained for successive segments of the content to the fingerprint of the first segment, searches for the resulting fingerprint, until the result of the comparison of the resulting fingerprint with the reference fingerprints 9 is sufficiently significant, and enables to decide whether the content is identified or not.

This embodiment corresponds to the case where the segments for which fingerprints are successively generated are not adjacent. The concatenation of these fingerprints is thus omitted, and during the synchronisation step, these fingerprints are each searched for as identifying a same content in the memory 10. The method is iterated until the length of the collected signal is sufficient to allow a significant comparison and enables to decide whether the content is identified or not.

It is to be noted that for identifying the content, the search module operating in the fingerprint computing server 8 makes successive comparisons of the digital fingerprint 12 generated by the first terminal to the reference fingerprint 9.

In a first alternative execution, the comparison consists in computing a distance between said fingerprints, that is between the generated digital fingerprint 12, and a segment of the reference fingerprint 9 with a same length. In this case, the content would be identified if the distance computed between said fingerprints is lower than a predefined threshold.

In another alternative, the comparison of the generated fingerprint 12 to the reference fingerprint 9 consists in computing a correlation value between said fingerprints, that is between the generated digital fingerprint 12, and a segment of the reference fingerprint 9 with a same length. In this case, the content is identified if the computed correlation value between said fingerprints is higher than a predefined threshold.

Any other pattern or fingerprint recognition method such as principal component analysis (PCA) on a histogram can be used without departing from the scope of the invention.

In a preferred embodiment of the invention, with each image of a broadcasted image is associated a digital value 20 comprising a time code indicating a date expressed in hours, minutes, seconds, and image number with respect to a program start. This program start is for example, for a content such as a movie, the instant corresponding to its first image, or, for a content such as a television channel, a given reference instant during its broadcasting. The identification of the broadcasted program is consequently made by the fingerprint computing server 8 based on such information, for example regarding the latest image of the fingerprint.

When the program is identified, the digital value 20 is transmitted to the first terminal 2 by the fingerprint computing server 8 via a Wi-Fi connection, a data link via a mobile telephone network, or via an SMS.

Then, in order to synchronise the application Second Screen with the content, the current instant in the content is determined by taking into account a delay of processing and searching for fingerprints, as well as of communicating, of a few seconds, or by computing it by means for example of a local clock based on storing the instant of start or end of luminosity collection, of transmission of the generated fingerprint to the fingerprint computing server 8, or of reception of the answer of the server 8. After synchronisation, the application Second Screen suggests to the user an interaction in connection with the event which is broadcasted in the current instant, such as additional information, a game, a survey, or an interaction with social networks. It can also suggest other programs in connection with the programme identified.

It is worth to note that when the luminosity is computed from the images acquired by means of a camera, the digital fingerprint 12 is generated from each colour component of these images. In this case, instead of comparing a single curve (corresponding to the luminance), the fingerprint computing server 8 can compare two or three of them (from respectively R, G, B or Y, U, V).

The method according to the invention is applicable to identify a live broadcasted content and to allow a synchronisation and a real time interaction with this content, in particular in the case of taking part in a game, a quiz or a survey.

The method is also applicable to identify on-demand (VOD) contents or a pre-stored content. In this case, the memory 10 contains the fingerprint of each of the contents, over the entire content duration. Further, the predetermined duration of the digital fingerprint 12 is longer in order to properly discriminate the program being displayed.

1-18. (canceled)

19. A method for identifying, via a first terminal, a content being displayed on . a screen of a second terminal located in the same space as the first terminal, including the following steps:
collecting with the first terminal the luminosity produced in said space by the second terminal,
generating with the first terminal at least one digital fingerprint depending on the collected luminosity,
comparing the generated fingerprint to a reference fingerprint stored beforehand in a memory,
identifying the content depending on the result of said comparison, which method is characterised in that the generated digital fingerprint represents the change over time in the collected luminosity for a predefined duration.

20. The method according to claim 19, wherein the generated digital fingerprint results from a sampling of the luminosity produced by the second terminal for the predefined duration.

21. The method according to claim 19, wherein the reference fingerprint is transmitted beforehand to said first terminal, and the comparison of the generated digital fingerprint to the reference fingerprint is performed by the first terminal.

22. The method according to claim 19, wherein the first terminal transmits the generated fingerprint to a fingerprint computing server which compares said generated fingerprint to the reference fingerprint.

23. The method according to claim 19, wherein the comparison of the generated fingerprint to the reference fingerprint consists in computing a distance between said fingerprints for a predefined duration, and wherein the content is identified if the computed distance between said fingerprints is lower than a predefined threshold.

24. The method according to claim 19, wherein the comparison of the generated fingerprint to the reference fingerprint consists in computing a correlation value between said fingerprints for the predefined duration, and wherein the content is identified if the computed correlation value between said fingerprints is higher than a predefined threshold.

25. The method according to claim 19, further including a step of synchronising an application operating on the first terminal with the display of the digital content identified on the screen of the second terminal.

26. The method according to claim 25, wherein the identifying step enables the position of the luminosity collecting duration predefined in the content to be obtained.

27. The method according to claim 26, wherein said application provides:
additional data regarding the displayed content, and/or,
data relating to a game in connection with the displayed content, and/or,
data relating to a survey in connection with the broadcasted content, and/or,
an interaction with the social network.

28. The method according to claim 19, wherein the luminosity is measured by means of a sensor integrated into the first terminal.

29. The method according to claim 19, wherein the luminosity is computed from images acquired by means of a camera integrated into the first terminal.

30. The method according to claim 29, wherein the generated digital fingerprint represents the change over time in the luminosity computed from a colour component of the images acquired for a predefined duration.

31. A device for identifying a content displayed on a screen among a plurality of contents provided by an operator, including:
a memory including a plurality of reference digital fingerprints, each reference fingerprint enabling a content to be identified among the contents provided,
a first terminal provided with means for collecting the luminosity produced in a space by the second terminal, and means for generating a digital fingerprint from the collected luminosity,
means for comparing the generated digital fingerprint to a reference fingerprint stored beforehand in the memory, and
means for identifying the displayed content,
characterised in that the generated digital fingerprint represents the change over time in the collected luminosity for a predefined duration.

32. The device according to claim 31, further including means for synchronising an application operating on the first terminal with the real time display of a digital content identified.

33. The device according to claim 31 wherein said terminal is a smartphone, a tablet, or a computer.

34. A communication terminal including means for collecting the luminosity produced by displaying a content displayed on a screen, means for generating a digital fingerprint depending on the collected luminosity, means for comparing the generated fingerprint to a reference fingerprint stored beforehand in a memory, and means for identifying the displayed content, characterised in that the generated digital fingerprint represents the change over time in the collected luminosity for a predefined duration.

35. A computer program stored on a storage medium including instructions for carrying out the steps of the method according to claim 19, when run on a computer.

36. The method according to claim 22, wherein the comparison of the generated fingerprint to the reference fingerprint consists in computing a distance between said fingerprints for a predefined duration, and wherein the content is identified if the computed distance between said fingerprints is lower than a predefined threshold.

37. The method according to claim 22, wherein the comparison of the generated fingerprint to the reference fingerprint consists in computing a correlation value between said fingerprints for the predefined duration, and wherein the content is identified if the computed correlation value between said fingerprints is higher than a predefined threshold.
